(19) United States
(12) Patent Application Publication
(10) Pub. No.: US 2009/0292627 A1
(43) Pub. Date: Nov. 26, 2009

(54) SYSTEM AND METHOD FOR MONITORING CONSUMABLE USAGE AND MANAGING CONSUMABLE INVENTORY

(76) Inventors: Marianne L. KODIMER, Huntington Beach, CA (US); Brenda Daos, Mission Viejo, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 12/125,479

(22) Filed: May 22, 2008

(51) Int. Cl. A01K 5/02

(52) U.S. Cl. 705/29

(57) ABSTRACT

The subject application is directed to a system and method for monitoring consumable usage and managing consumable inventory. An order for a document processing device consumable is first received from a user account, and an inventory value corresponding to each received order is then stored. Consumable full, empty, and low status data is then received from each document processing device associated with the user account. The inventory value is then decremented during each transition reflected in the status data to a full level. An order for additional consumables is then indicated for the user account when the inventory level is decremented to a preselected trigger amount. Imminent replacement data is then generated corresponding to each document processing device having a low level consumable status. The inventory value is then compared to the imminent replacement data and an order is indicated for additional consumables based upon the comparison results

### BACKGROUND OF THE INVENTION

The subject application pertains generally to assisted monitoring and ordering of consumables so as to maintain sufficient inventory such that all devices remain operational. The application is particularly applicable to monitoring and replacement of consumables, such as toner or paper supply, for use with a plurality of networked document processing devices disposed throughout an enterprise.

Many devices use consumables which must be periodically restocked or replaced so that the device remains in full service. By way of example, document processing devices such as copiers or printers, require paper and ink or toner to operate. For color devices, the ink or toner is typically comprised of a plurality of primary colors, such as cyan, magenta and yellow, usually supplemented by black, for CMYK rendering. Many devices will generate a display, either locally or remotely, that a monitored consumable is depleted, or supply limited. Failure to replace a consumable may render a device inoperable, or only partially operable, such as being limited to printing in black and white as opposed to color.

Enterprises with many devices to support will typically have a supply room where replacement consumables may be found. Having too much inventory can be an expensive proposition. Having too few consumables can result in insufficient replacement resources when too many devices require simultaneous replacement.

Some devices allow for remote monitoring of consumables. Many suppliers also allow for remote ordering of consumables, such as via orders placed via an Internet web browser. There is a substantial burden for monitoring consumable usage and ordering accurately, particularly for large enterprises. Some suppliers have attempted to remotely monitor devices for placing orders. However, opening up one's network to a third party for device monitoring poses a security threat.

### SUMMARY OF THE INVENTION

In accordance with one embodiment of the subject application, there is provided a system and method for assisted monitoring and ordering of consumables so as to maintain sufficient inventory such that all devices remain operational.

Further, in accordance with one embodiment of the subject application, there is provided a system and method for the monitoring and replacement of consumables, such as toner or paper supply, for use with a plurality of networked document processing devices disposed throughout an enterprise.

Still further in accordance with one embodiment of the subject application, there is provided a system for monitoring consumable usage and managing consumable inventory. The system comprises means adapted for receiving at least one order for document processing device consumables from a user account and storage means adapted for storing an inventory value associated with the user account corresponding to each received order. The system also comprises means adapted for receiving consumable status data from each of a plurality of document processing devices associated with the user account, the status data including data representative of a status of full level, a status of empty level, and a status of low level relative to consumables used with the document processing device. The system further comprises means adapted for decrementing the inventory value during each transition reflected in the status data to a full level and order indication means adapted for indicating an order for additional consumables for the user account when the inventory level is decremented to a preselected trigger amount. The system also includes means adapted for generating imminent replacement data corresponding to each document processing device having a low level consumable status and comparison means adapted for comparing the inventory value to the imminent replacement data. In addition, the order indication means further includes means adapted for indicating an order for additional consumables in accordance with an output of the comparison means.

Still further, in accordance with one embodiment of the subject application, there is provided a method for monitoring consumable usage and managing consumable inventory in accordance with the system as set forth above. The method includes the step of receiving at least one order for document processing device consumables from a user account. The method also includes the steps of storing an inventory value associated with the user account corresponding to each received order, and receiving consumable status data from each of a plurality of document processing devices associated with the user account. The status data further includes data representing a status of full level, a status of empty level, and a status of low level relative to consumables used with the document processing device. In addition, the method includes the steps of decrementing the inventory value during each transition reflected in the status data to a full level, and indicating an order for additional consumables for the user account when the inventory level is decremented to a preselected trigger amount. The method also comprises the step of generating imminent replacement data corresponding to each document processing device having a low level consumable status. Furthermore, the method includes the steps of comparing the inventory value to the imminent replacement data, and indicating an order for additional consumables in accordance with the output of the comparison step.

Still other advantages, aspects and features of the subject application will become readily apparent to those skilled in the art from the following description wherein there is shown and described a preferred embodiment of the subject application, simply by way of illustration of one of the modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a system for monitoring consumable usage and managing consumable inventory according to one embodiment of the subject application;

FIG. 2 is a block diagram illustrating device hardware for use in the system for monitoring consumable usage and managing consumable inventory according to one embodiment of the subject application;

FIG. 3 is a functional diagram illustrating the device for use in the system for monitoring consumable usage and managing consumable inventory according to one embodiment of the subject application;

FIG. 4 is a block diagram illustrating controller hardware for use in the system for monitoring consumable usage and managing consumable inventory according to one embodiment of the subject application;

FIG. 5 is a functional diagram illustrating the controller for use in the system for monitoring consumable usage and managing consumable inventory according to one embodiment of the subject application;

FIG. 6 is a functional diagram illustrating an administrative device for use in the system for monitoring consumable usage and managing consumable inventory according to one embodiment of the subject application;

FIG. 7 is a functional diagram illustrating a server for use in the system for monitoring consumable usage and managing consumable inventory according to one embodiment of the subject application;

FIG. 8 is a flowchart illustrating a method for monitoring consumable usage and managing consumable inventory according to one embodiment of the subject application; and

FIG. 9 is a flowchart illustrating a method for monitoring consumable usage and managing consumable inventory according to one embodiment of the subject application.

### DETAILED DESCRIPTION OF THE PREFERRED EMBODIMENT

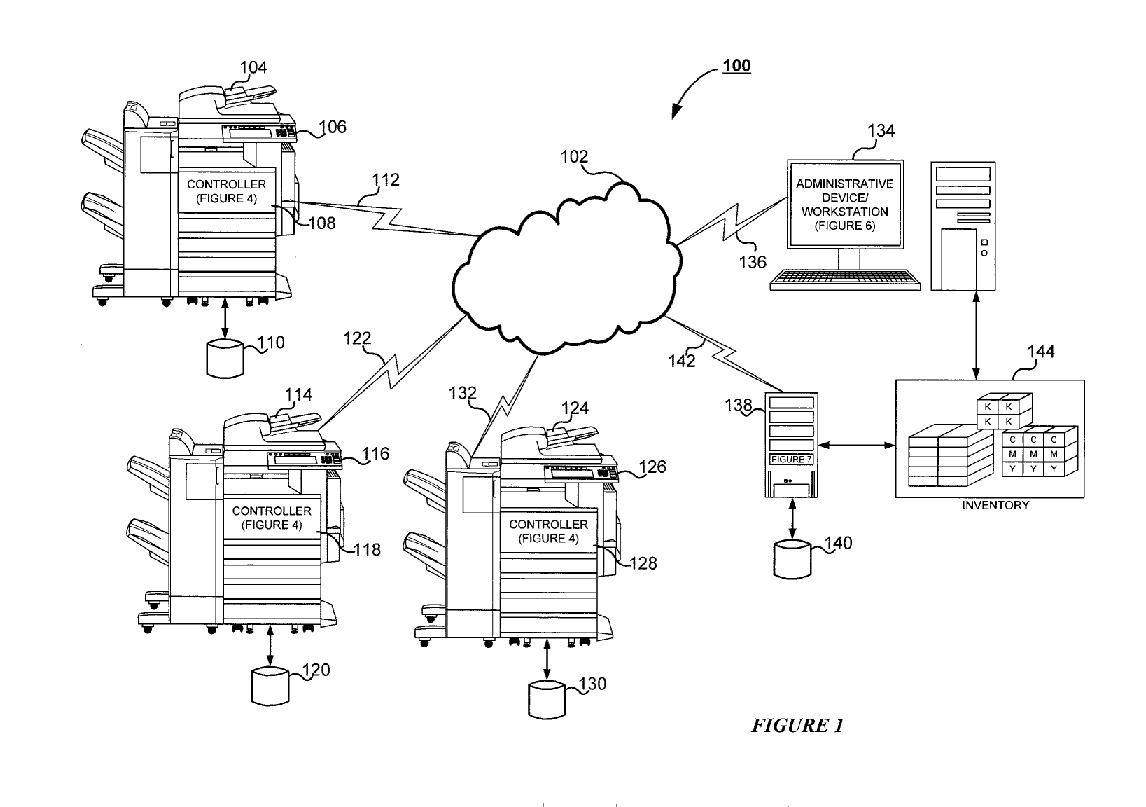

The subject application is directed to a system and method for monitoring consumable usage and managing consumable inventory. In particular, the subject application is directed to a system and method for assisted monitoring and ordering of consumables so as to maintain sufficient inventory such that all devices remain operational. More particularly, the subject application is directed to a system and method for the monitoring and replacement of consumables, such as toner or paper supply, for use with a plurality of networked document processing devices disposed throughout an enterprise. It will become apparent to those skilled in the art that the system and method described herein are suitably adapted to a plurality of varying electronic fields employing remote monitoring, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of a system 100 for monitoring consumable usage and managing consumable inventory in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also consists of one or more document processing devices, depicted in FIG. 1 as the document processing devices 104, 114, and 124. As shown in FIG. 1, the document processing devices 104, 114, and 124 are illustrated as multifunction peripheral devices, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing devices 104, 114, and 124 are suitably adapted to provide remote document processing services to external or network devices. Preferably, the document processing devices 104, 114, and 124 include hardware, software, and any suitable combination thereof, configured to interact with an associated user, a networked device, or the like.

According to one embodiment of the subject application, the document processing devices 104, 114, and 124 are suitably equipped to receive a plurality of portable storage media, including, without limitation, Firewire drive, USB drive, SD, MMC, XD, Compact Flash, Memory Stick, and the like. In the preferred embodiment of the subject application, the document processing devices 104, 114, and 124 further include associated user interfaces 106, 116, and 126, such as a touch-screen, LCD display, touch-panel, alpha-numeric keypad, or the like, via which an associated user is able to interact directly with the document processing devices 104, 114, and 124. In accordance with the preferred embodiment of the subject application, the user interfaces 106, 116, and 126 are advantageously used to communicate information to associated users and receive selections from such associated users.

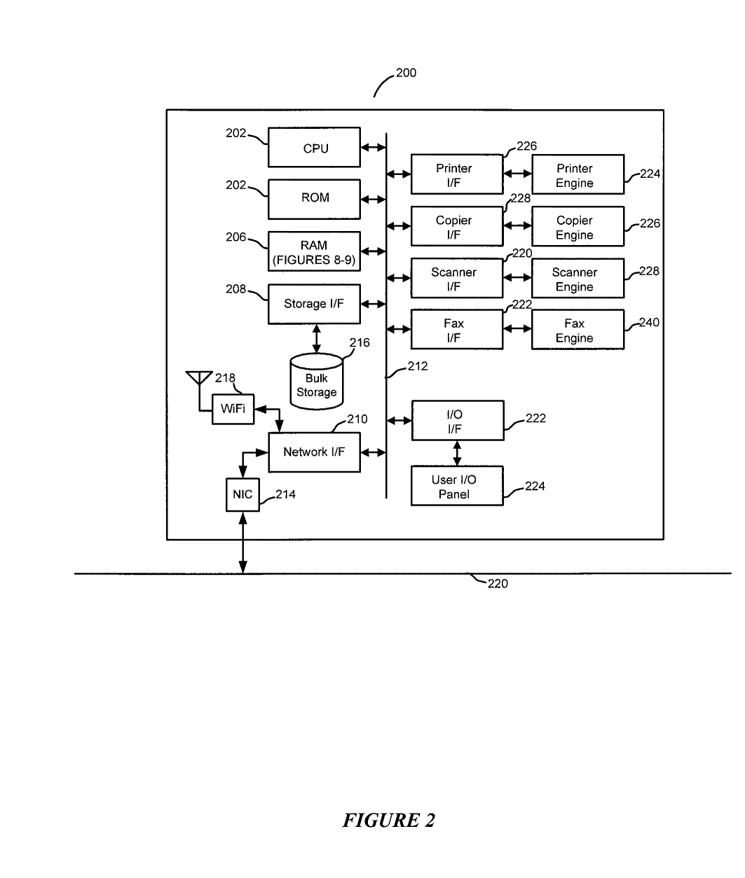

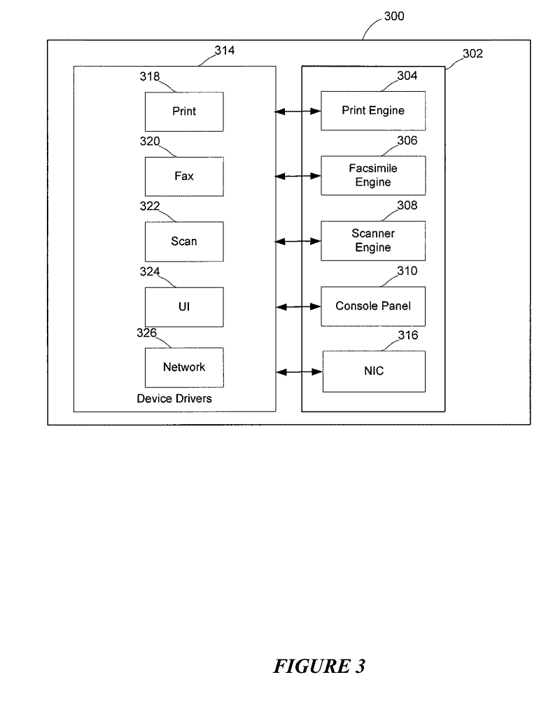

The skilled artisan will appreciate that the user interfaces 106, 116, and 126 comprise various components, suitably adapted to present data to associated users, as are known in the art. In accordance with one embodiment of the subject application, the user interfaces 106, 116, and 126 comprise a display, suitably adapted to display one or more graphical elements, text data, images, or the like, to an associated user, receive input from the associated user, and communicate the same to a backend component, such as controllers 108, 118, and 128, as explained in greater detail below. Preferably, the document processing devices 104, 114, and 124 are communicatively coupled to the computer network 102 via suitable communications links 112, 122, and 132. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art. The functioning of the document processing devices 104, 114, and 124 will be better understood in conjunction with the block diagrams illustrated in FIGS. 2 and 3, explained in greater detail below.

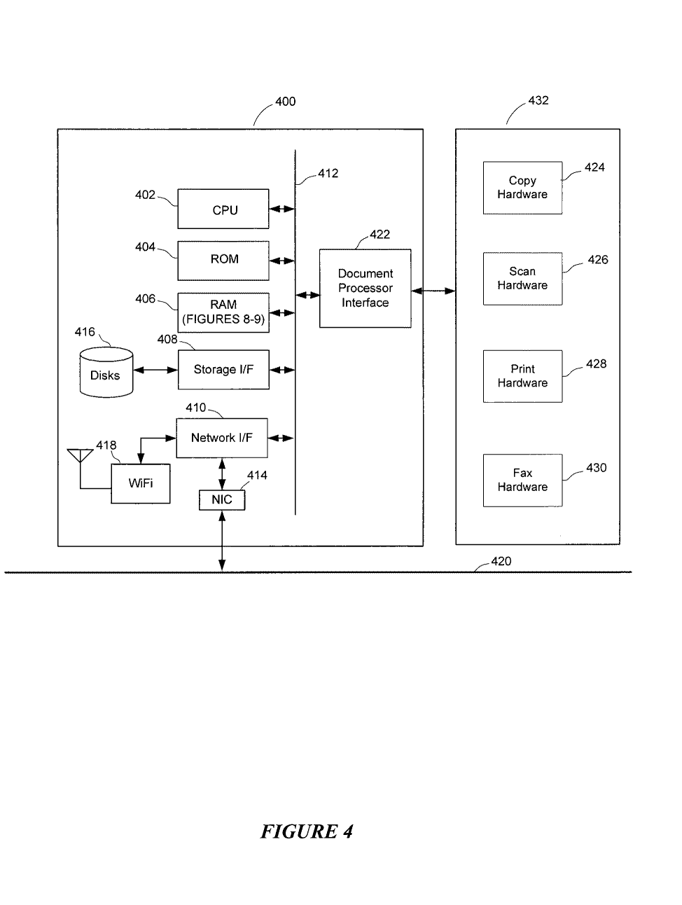

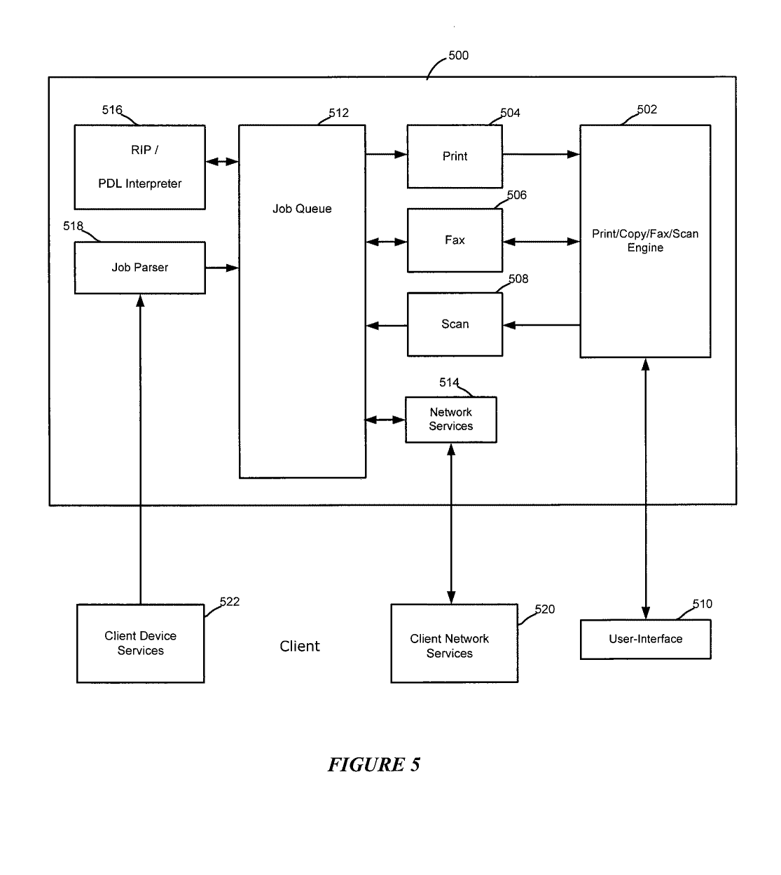

In accordance with one embodiment of the subject application, the document processing devices 104, 114, and 124 further incorporate a backend component, designated as the controllers 108, 118, and 128, suitably adapted to facilitate the operations of their respective document processing devices 104, 114, and 124, as will be understood by those skilled in the art. Preferably, the controllers 108, 118, and 128 are embodied as hardware, software, or any suitable combination thereof, configured to control the operations of the associated document processing devices 104, 114, and 124, facilitate the display of images via the user interfaces 106, 116, and 126, direct the manipulation of electronic image data, and the like. For purposes of explanation, the controllers 108, 118, and 128 are used to refer to any myriad of components associated with the document processing devices 104, 114, and 124, including hardware, software, or combinations thereof, functioning to perform, cause to be performed, control, or otherwise direct the methodologies described hereinafter. It will be understood by those skilled in the art that the methodologies described with respect to the controllers 108, 118, and 128 are capable of being performed by any general purpose computing system, known in the art, and thus the controllers 108, 118, and 128 are representative of such a general computing device and is intended as such when used hereinafter. Furthermore, the use of the controllers 108, 118, and 128 hereinafter is for the example embodiment only, and other embodiments, which will be apparent to one skilled in the art, are capable of employing the system and method for monitoring consumable usage and managing consumable inventory of the subject application. The functioning of the controllers 108, 118, and 128 will better be understood in conjunction with the block diagrams illustrated in FIGS. 4 and 5, explained in greater detail below.

Communicatively coupled to the document processing devices 104, 114, and 124 are data storage devices 110, 120, and 130. In accordance with the preferred embodiment of the subject application, the data storage devices 110, 120, and 130 are any mass storage device known in the art including, for example and without limitation, magnetic storage drives, a hard disk drive, optical storage devices, flash memory devices, or any suitable combination thereof. In the preferred embodiment, the data storage devices 110, 120, and 130 are suitably adapted to store document data, image data, electronic database data, or the like. It will be appreciated by those skilled in the art that while illustrated in FIG. 1 as being a separate component of the system 100, the data storage devices 110, 120, and 130 are capable of being implemented as internal storage components of the document processing devices 104, 114, and 124, components of the controllers 108, 118, and 128, or the like, such as, for example and without limitation, an internal hard disk drive, or the like.

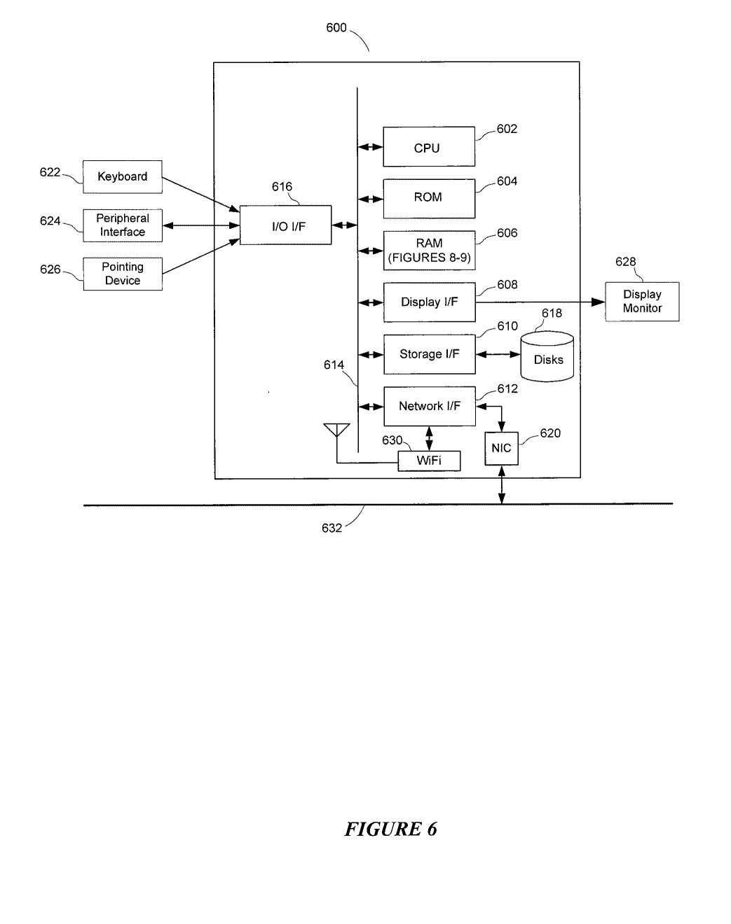

The system 100 illustrated in FIG. 1 further depicts an administrative device 134, in data communication with the computer network 102 via a communications link 136. It will be appreciated by those skilled in the art that the administrative device 134 is shown in FIG. 1 as a computer workstation for illustration purposes only. As will be understood by those skilled in the art, the administrative device 134 is representative of any personal computing device known in the art, including, for example and without limitation, a laptop computer, a personal computer, a personal data assistant, a web-enabled cellular telephone, a smart phone, a proprietary network device, or other web-enabled electronic device. The communications link 136 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the administrative device 134 is suitably adapted to monitor operations of the computer network 102, the document processing devices 104, 114, and 124, or any other similar device coupled to the computer network 102, correspond with third party suppliers, connect to the Internet, communicate with a backend database, e.g. server 138, and the like. The functioning of the administrative device 134 will better be understood in conjunction with the block diagram illustrated in FIG. 6, explained in greater detail below.

The system 100 of FIG. 1 also includes a server 138 suitably adapted to facilitate the management of an inventory database 140 representative of an inventory 144 of consumable supplies for the document processing devices 104, 114, and 124. Preferably, the server 138 is communicatively coupled to the computer network 102 via a suitable communications link 142. It will be appreciated by those skilled in the art that the server 138 comprises hardware, software, and combinations thereof suitably adapted to provide one or more services, web-based applications, storage options, and the like, to networked devices. In accordance with one embodiment of the subject application, the server 138 includes various components, implemented as hardware, software, or a combination thereof, for managing the retention of electronic data, performing searches, storing advertisements, storing account information, storing billing information, retrieval of documents, and the like, which are accessed via the computer network 102. The communications link 142 is any suitable data communications means known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. It will be appreciated by those skilled in the art that the components described with respect to the server 138 hereinafter are capable of implementation on any computing device coupled to the computer network 102 and functioning as a backend server.

Communicatively coupled to the server 138 is the data storage device 140. In accordance with the preferred embodiment of the subject application, the data storage device 140 is any mass storage device, or plurality of such devices, known in the art including, for example and without limitation, magnetic storage drives, a hard disk drive, optical storage devices, flash memory devices, or any suitable combination thereof. In the preferred embodiment, the data storage device 140 is suitably adapted to store consumable supply data, such as an inventory database, software updates, update lists, electronic database data, document data, image data, location data, advertisement data, account data, user data, and the like. It will be appreciated by those skilled in the art that while illustrated in FIG. 1 as being a separate component of the system 100, the data storage device 140 is capable of being implemented as internal storage component of the server 138, or the like, such as, for example and without limitation, an internal hard disk drive, or the like.

The inventory 144 is representative of all consumables available for replenishing the document processing devices 104, 114, and 124. It will be appreciated by those skilled in the art that suitable examples of such consumables include, without limitation, black toner, cyan toner, magenta toner, yellow toner, light gray toner, medium gray toner, inks, ink heads, paper, staples, and other consumable materials and parts associated with the operations of the document processing devices 104, 114, and 124. In accordance with one embodiment of the subject application, the contents of the inventory 144 are preferably stored in the inventory database 140, accessible to the administrative device 134 via the computer network 102.

Turning now to FIG. 2, illustrated is a representative architecture of a suitable device 200, shown in FIG. 1 as the document processing devices 104, 114, and 124, on which operations of the subject system are completed. Included is a processor 202, suitably comprised of a central processor unit. However, it will be appreciated that the processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the device 200.

Also included in the device 200 is random access memory 206, suitably formed of dynamic random access memory, static random access memory, or any other suitable, addressable memory system. Random access memory provides a storage area for data instructions associated with applications and data handling accomplished by the processor 202.

A storage interface 208 suitably provides a mechanism for volatile, bulk or long term storage of data associated with the device 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the device 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 214 is interconnected for data interchange via a physical network 220, suitably comprised of a local area network, wide area network, or a combination thereof.

Data communication between the processor 202, read only memory 204, random access memory 206, storage interface 208 and the network subsystem 210 is suitably accomplished via a bus data transfer mechanism, such as illustrated by the bus 212.

Suitable executable instructions on the device 200 facilitate communication with a plurality of external devices, such as workstations, document processing devices, other servers, or the like. While, in operation, a typical device operates autonomously, it is to be appreciated that direct control by a local user is sometimes desirable, and is suitably accomplished via an optional input/output interface 222 to a user input/output panel 224 as will be appreciated by one of ordinary skill in the art.

Also in data communication with the bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document processing device, depicted in FIG. 1 as the document processing devices 104, 114, and 124, for use in connection with the disclosed system. FIG. 3 illustrates suitable functionality of the hardware of FIG. 2 in connection with software and operating system functionality as will be appreciated by one of ordinary skill in the art. The document processing device 300 suitably includes an engine 302 which facilitates one or more document processing operations.

The document processing engine 302 suitably includes a print engine 304, facsimile engine 306, scanner engine 308 and console panel 310. The print engine 304 allows for output of physical documents representative of an electronic document communicated to the processing device 300. The facsimile engine 306 suitably communicates to or from external facsimile devices via a device, such as a fax modem.

The scanner engine 308 suitably functions to receive hard copy documents and in turn image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format, and is also suitably configured for optical character recognition. Tangible document scanning also suitably functions to facilitate facsimile output thereof.

In the illustration of FIG. 3, the document processing engine also comprises an interface 316 with a network via driver 326, suitably comprised of a network interface card. It will be appreciated that a network thoroughly accomplishes that interchange via any suitable physical and non-physical layer, such as wired, wireless, or optical data communication.

The document processing engine 302 is suitably in data communication with one or more device drivers 314, which device drivers allow for data interchange from the document processing engine 302 to one or more physical devices to accomplish the actual document processing operations. Such document processing operations include one or more of printing via driver 318, facsimile communication via driver 320, scanning via driver 322 and a user interface functions via driver 324. It will be appreciated that these various devices are integrated with one or more corresponding engines associated with the document processing engine 302. It is to be appreciated that any set or subset of document processing operations are contemplated herein. Document processors which include a plurality of available document processing options are referred to as multi-function peripherals.

Turning now to FIG. 4, illustrated is a representative architecture of a suitable backend component, i.e., the controller 400, shown in FIG. 1 as the controllers 108, 118, and 128, on which operations of the subject system 100 are completed. The skilled artisan will understand that the controller 400 is representative of any general computing device, known in the art, capable of facilitating the methodologies described herein. Included is a processor 402, suitably comprised of a central processor unit. However, it will be appreciated that processor 402 may advantageously be composed of multiple processors working in concert with one another as will be appreciated by one of ordinary skill in the art. Also included is a non-volatile or read only memory 404 which is advantageously used for static or fixed data or instructions, such as BIOS functions, system functions, system configuration data, and other routines or data used for operation of the controller 400.

Also included in the controller 400 is random access memory 406, suitably formed of dynamic random access memory, static random access memory, or any other suitable, addressable and writable memory system. Random access memory provides a storage area for data instructions associated with applications and data handling accomplished by processor 402.

A storage interface 408 suitably provides a mechanism for non-volatile, bulk or long term storage of data associated with the controller 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the controller 400 to communicate to other devices. The network interface subsystem 410 suitably interfaces with one or more connections with external devices to the device 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 414 is interconnected for data interchange via a physical network 420, suitably comprised of a local area network, wide area network, or a combination thereof.

Data communication between the processor 402, read only memory 404, random access memory 406, storage interface 408 and the network interface subsystem 410 is suitably accomplished via a bus data transfer mechanism, such as illustrated by bus 412.

Also in data communication with the bus 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 400 of FIG. 4, (shown in FIG. 1 as the controllers 108, 118, and 128) as an intelligent subsystem associated with a document processing device. In the illustration of FIG. 5, controller function 500 in the preferred embodiment, includes a document processing engine 502. A suitable controller functionality is that incorporated into the Toshiba e-Studio system in the preferred embodiment. FIG. 5 illustrates suitable functionality of the hardware of FIG. 4 in connection with software and operating system functionality as will be appreciated by one of ordinary skill in the art.

In the preferred embodiment, the engine 502 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that perform one or more of the document processing operations listed above.

The engine 502 is suitably interfaced to a user interface panel 510, which panel allows for a user or administrator to access functionality controlled by the engine 502. Access is suitably enabled via an interface local to the controller, or remotely via a remote thin or thick client.

The engine 502 is in data communication with the print function 504, facsimile function 506, and scan function 508. These functions facilitate the actual operation of printing, facsimile transmission and reception, and document scanning for use in securing document images for copying or generating electronic versions.

A job queue 512 is suitably in data communication with the print function 504, facsimile function 506, and scan function 308. It will be appreciated that various image forms, such as bit map, page description language or vector format, and the like, are suitably relayed from the scan function 308 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supplies data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter or any suitable mechanism for interchange of an electronic document to a format better suited for interchange with device functions such as print 504, facsimile 506 or scan 508.

Finally, the job queue 512 is in data communication with a parser 518, which parser suitably functions to receive print job language files from an external device, such as client device services 522. The client device services 522 suitably include printing, facsimile transmission, or other suitable input of an electronic document for which handling by the controller function 500 is advantageous. The parser 518 functions to interpret a received electronic document file and relay it to the job queue 512 for handling in connection with the afore-described functionality and components.

Turning now to FIG. 6, illustrated is a hardware diagram of a suitable workstation 600, shown in FIG. 1 as the administrative device 134, for use in connection with the subject system. A suitable workstation includes a processor unit 602 which is advantageously placed in data communication with read only memory 604, suitably non-volatile read only memory, volatile read only memory or a combination thereof, random access memory 606, display interface 608, storage interface 610, and network interface 612. In a preferred embodiment, interface to the foregoing modules is suitably accomplished via a bus 614.

The read only memory 604 suitably includes firmware, such as static data or fixed instructions, such as BIOS, system functions, configuration data, and other routines used for operation of the workstation 600 via CPU 602.

The random access memory 606 provides a storage area for data and instructions associated with applications and data handling accomplished by the processor 602.

The display interface 608 receives data or instructions from other components on the bus 614, which data is specific to generating a display to facilitate a user interface. The display interface 608 suitably provides output to a display terminal 628, suitably a video display device such as a monitor, LCD, plasma, or any other suitable visual output device as will be appreciated by one of ordinary skill in the art.

The storage interface 610 suitably provides a mechanism for non-volatile, bulk or long term storage of data or instructions in the workstation 600. The storage interface 610 suitably uses a storage mechanism, such as storage 618, suitably comprised of a disk, tape, CD, DVD, or other relatively higher capacity addressable or serial storage medium.

The network interface 612 suitably communicates to at least one other network interface, shown as network interface 620, such as a network interface card, and wireless network interface 630, such as a WiFi wireless network card. It will be appreciated that by one of ordinary skill in the art that a suitable network interface is comprised of both physical and protocol layers and is suitably any wired system, such as Ethernet, token ring, or any other wide area or local area network communication system, or wireless system, such as WiFi, WiMax, or any other suitable wireless network system, as will be appreciated by one of ordinary skill in the art. In the illustration, the network interface 620 is interconnected for data interchange via a physical network 632, suitably comprised of a local area network, wide area network, or a combination thereof.

An input/output interface 616 in data communication with the bus 614 is suitably connected with an input device 622, such as a keyboard or the like. The input/output interface 616 also suitably provides data output to a peripheral interface 624, such as a USB, universal serial bus output, SCSI, Firewire (IEEE 1394) output, or any other interface as may be appropriate for a selected application. Finally, the input/output interface 616 is suitably in data communication with a pointing device interface 626 for connection with devices, such as a mouse, light pen, touch screen, or the like.

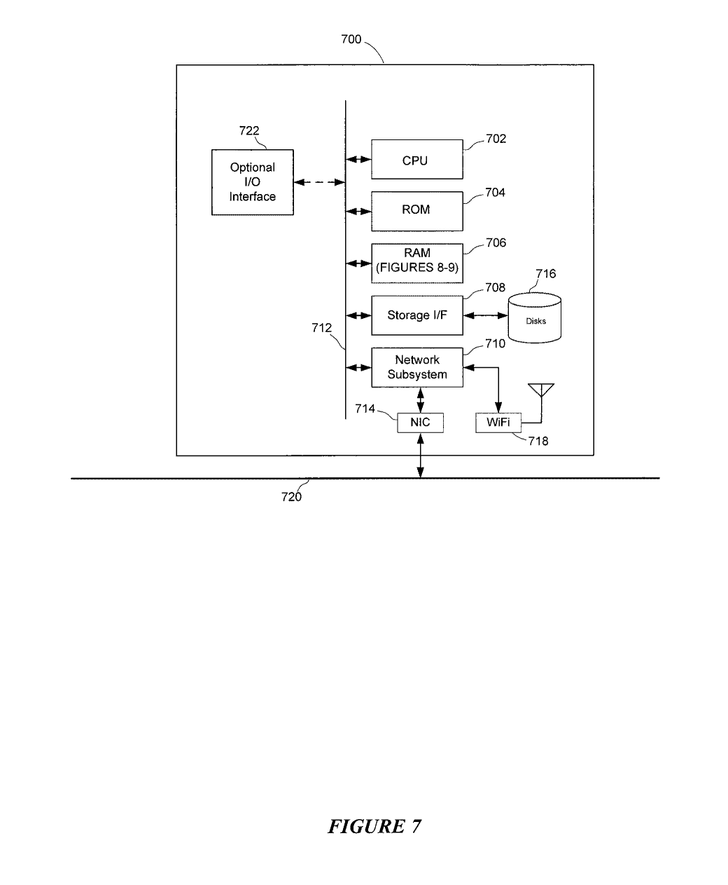

Turning now to FIG. 7, illustrated is a representative architecture of a suitable server 700, shown in FIG. 1 as the server 138, on which operations of the subject system are completed. Included is a processor 702, suitably comprised of a central processor unit. However, it will be appreciated that processor 702 may advantageously be composed of multiple processors working in concert with one another as will be appreciated by one of ordinary skill in the art. Also included is a non-volatile or read only memory 704 which is advantageously used for static or fixed data or instructions, such as BIOS functions, system functions, system configuration, and other routines or data used for operation of the server 700.

Also included in the server 700 is random access memory 706, suitably formed of dynamic random access memory, static random access memory, or any other suitable, addressable memory system. Random access memory provides a storage area for data instructions associated with applications and data handling accomplished by the processor 702.

A storage interface 708 suitably provides a mechanism for volatile, bulk or long term storage of data associated with the server 700. The storage interface 708 suitably uses bulk storage, such as any suitable addressable or serial storage, such as a disk, optical, tape drive and the like as shown as 716, as well as any suitable storage medium as will be appreciated by one of ordinary skill in the art.

A network interface subsystem 710 suitably routes input and output from an associated network allowing the server 700 to communicate to other devices. The network interface subsystem 710 suitably interfaces with one or more connections with external devices to the server 700. By way of example, illustrated is at least one network interface card 714 for data communication with fixed or wired networks, such as Ethernet, token ring, and the like, and a wireless interface 718, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 714 is interconnected for data interchange via a physical network 720, suitably comprised of a local area network, wide area network, or a combination thereof.

Data communication between the processor 702, read only memory 704, random access memory 706, storage interface 708 and the network subsystem 710 is suitably accomplished via a bus data transfer mechanism, such as illustrated by bus 712.

Suitable executable instructions on the server 700 facilitate communication with a plurality of external devices, such as workstations, document processing devices, other servers, or the like. While, in operation, a typical server operates autonomously, it is to be appreciated that direct control by a local user is sometimes desirable, and is suitably accomplished via an optional input/output interface 722 as will be appreciated by one of ordinary skill in the art.

In operation, at least one order for document processing device consumable is received from a user account. An inventory value associated with the user account corresponding to each received order is then stored. Consumable status data is then received from each document processing device associated with the user account. The status data includes data representing the status of a full level, an empty level, and a low level relative to consumables used with the document processing device. The inventory value is then decremented during each transition reflected in the status data to a full level. An order for additional consumables is then indicated for the user account when the inventory level is decremented to a preselected trigger amount. Imminent replacement data is then generated corresponding to each document processing device having a low level consumable status. The inventory value is then compared to the imminent replacement data and an order is indicated for additional consumables in accordance with the comparison results.

In accordance with one example embodiment of the subject application, an inventory monitoring component associated with a user account, such as hardware, software, or a combination thereof, is first initiated by the administrative device 134, the inventory server 138, or other suitable device associated with the computer network 102. It will be appreciated by those skilled in the art that the monitoring component is referenced hereinafter as residing on the administrative device 134 for example purposes only. Preferably, the monitoring component facilitates the monitoring of the inventory 144, e.g. available toner cartridges, reams of paper, staples, and other consumables used in document processing, as will be known in the art.

The administrative device 134 then analyzes the inventory 144 to determine whether any consumables in the inventory 144 meet a minimum threshold level. In accordance with one embodiment of the subject application, the administrative device 134 queries the server 138 and inventory database 140 for inventory values corresponding to the available consumables so as to determine whether any consumables require replenishment. For example, the inventory 144 includes five cyan toner cartridges, five magenta toner cartridges, and only one yellow toner cartridge. In such an example, a minimum of five toner cartridges for each color has been selected by the administrative user, thereby setting the minimum inventory level of five.

When the inventory minimum level has been met for a given consumable, the user associated with the user account is notified via any suitable means known in the art. Suitable means of notifying the user include, for example and without limitation, a popup window on the administrative device 134, an electronic mail message, an SMS message, a facsimile transmission, telephonic notification, or the like. Preferably, the monitoring component associated with the administrative device 134 includes a graphical user interface so as to enable interaction between the monitoring component and the user. The inventory value associated with the consumable is then displayed to the user on the administrative device and an order is then indicated to the user for replenishment of the consumable. The user is then prompted to order additional consumables for the user account based upon the returned inventory value. In accordance with one embodiment of the subject application, the administrative device 134 displays a suitable order prompt so as to place an order for replenishment consumables. According to one embodiment of the subject application, the placement of the order is undertaken automatically via the communication from the administrative device 134 to a suitable third-party vendor. The skilled artisan will appreciate that user is also capable of placing the order for replenishment of consumables manually via the administrative device 134.

Once the order has been placed for additional consumables, the inventory value is incremented to reflect the additional consumables ordered. Preferably, this incrementing of the inventory value is stored in the inventory database 140 associated with the server 138. The inventory amount displayed to the user via the administrative device 134 is then accordingly updated reflecting the ordered consumables.

The monitoring component associated with the administrative device 134 then receives status data from each of the document processing devices 104, 114, and 124 associated with the user account via the computer network 102. In accordance with one embodiment of the subject application, the status data reflects the status of consumables associated with each device 104, 114, and 124, including, for example and without limitation, toner full/low status, paper full/low status, staples full/low status, and the like. Preferably, the status data from each device 104, 114, and 124 includes the associated toner full/low status of each color available on the corresponding device 104, 114, and 124.

The monitoring component then determines whether any status data indicates a low consumable. When a low level of a consumable is determined from the status data, the monitoring component generates imminent replacement data identifying the document processing device 104, 114, or 124, and the corresponding consumable that is low, i.e. requires replenishment. The imminent replacement data is then compared with the inventory values associated with the identified consumable and displayed to the user via the administrative device 134. In the event that an order of replacement consumables is required as a result of the comparison, the user is prompted via the administrative device 134 to place such an order for the consumables. Preferably, the inventory value associated with the consumable is updated in the inventory database 140 in accordance with the placed order. Once the order has been placed, the inventory is updated so as to reflect the order. Such an update is suitably displayed thereafter on the graphical user interface displayed to the user via the administrative device 134.

When an order is not immediately indicated, or after successful placement of a replenishment order, the monitoring component associated with the administrative device 134 determines whether or not the low-level status consumable has been replaced. If the consumable has not yet been replaced, the user is prompted via any suitable means to facilitate the replacement of the consumable. Once the monitoring component determines that the consumable status data associated with the previously identified low-level status has a full-level status (indicating that the consumable has been refreshed, reloaded, replaced), the inventory value associated with that consumable is decremented so as to reflect the usage of the consumable from the inventory 144. The inventory amount displayed to the user is then updated to reflect the decremented inventory value via the administrative device 134. Following the updating of the display to the user, the monitoring component then determines whether any of the inventory values meet a minimum level, prompting replenishment of the inventory 144 accordingly. The monitoring of the status of the consumables associated with the document processing devices 104, 114, and 124 then continue as set forth above.

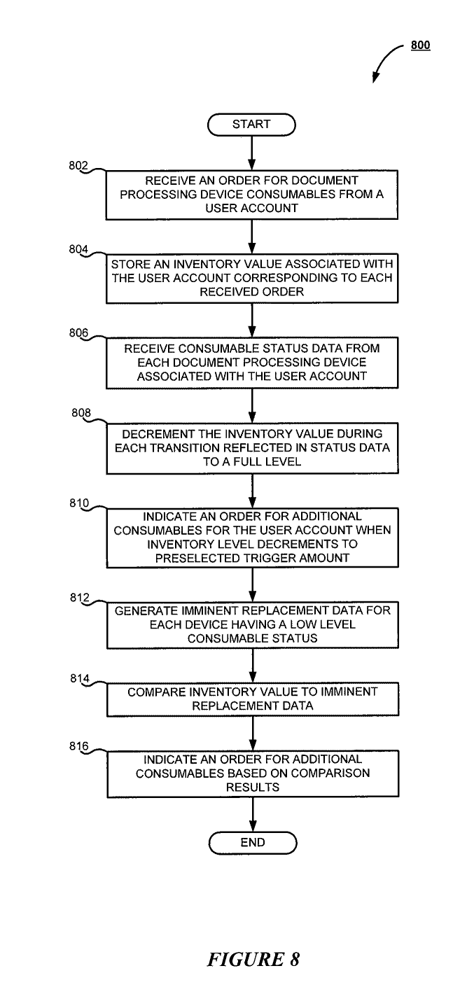

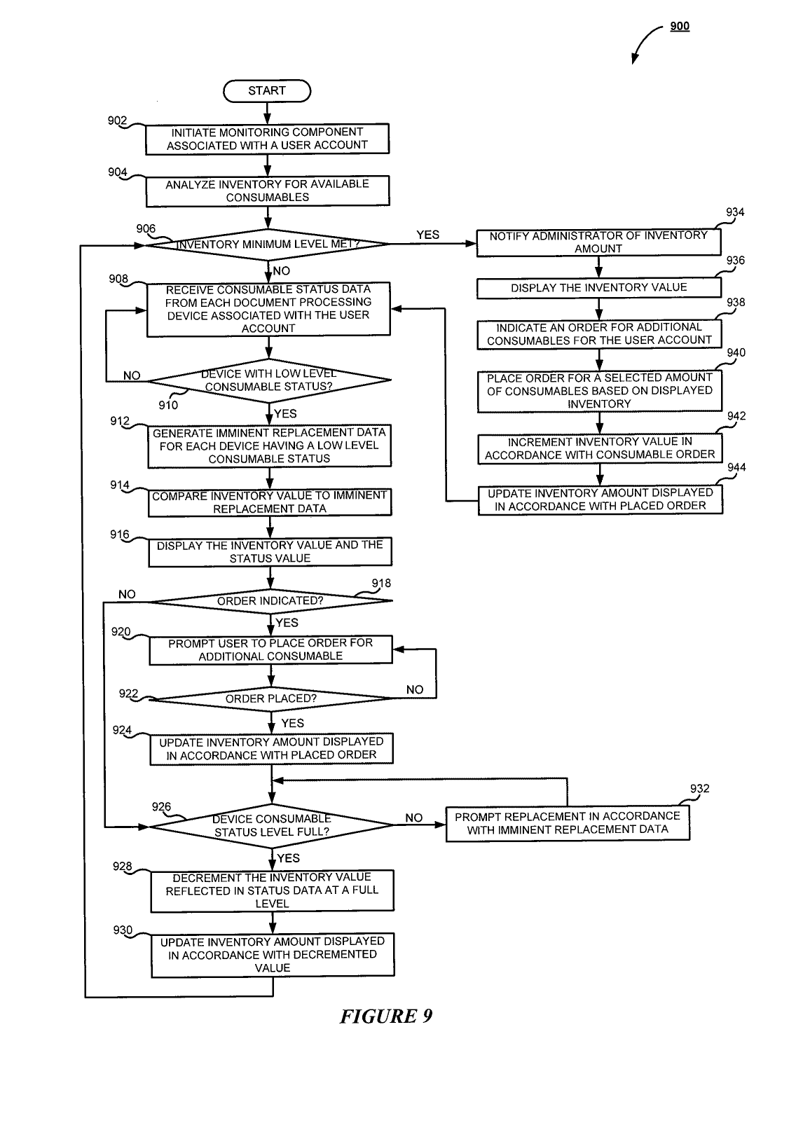

The skilled artisan will appreciate that the subject system 100 and components described above with respect to FIG. 1, FIG. 2, FIG. 3, FIG. 4, FIG. 5, FIG. 6, and FIG. 7 will be better understood in conjunction with the methodologies described hereinafter with respect to FIG. 8 and FIG. 9. Turning now to FIG. 8, there is shown a flowchart 800 illustrating a method for monitoring consumable usage and managing consumable inventory in accordance with one embodiment of the subject application. Beginning at step 802, an order for a document processing device consumable, e.g. toner, paper, ink, staples, etc., is received from a user account. In accordance with one embodiment of the subject application, a user associated with the administrative device 134 submits such an order in accordance with a user account. It will be appreciated by those skilled in the art that the user account is capable of being maintained on a third-party device (not shown) such as a web-based retailer.

An inventory value is then stored in association with the user account corresponding to each received order at step 804. It will be appreciated by those skilled in the art that such association is capable of being stored on the administrative device 134, the inventory server 138, the third-party retailer device (not shown), or the like. At step 806 consumable status data is received from each of the document processing devices 104, 114, and 124 associated with the user account. Preferably, each of the document processing devices 104, 114, and 124 coupled to the computer network 102 is monitored by the administrative device 134 or a suitable component thereof. The status data includes, for example and without limitation, the level of cyan, magenta, yellow, or black colorant remaining, the amount of output media, or the like. According to one embodiment of the subject application, the status data represents a low toner status, a full toner status, an associated color, or the like.

The stored inventory value is then decremented at step 808 during each transition of an associated document processing device 104 from a low (empty) status to a full status at step 808. That is, when a consumable is used, i.e. replaced in a document processing device 104, 114, or 124, the inventory 144 is reduced (decremented) to indicate that such a consumable is no longer available in inventory 144.

At step 810, an indication that an order for additional consumables for the user account is made when the inventory level is decremented to a preselected trigger amount. The skilled artisan will appreciate that at step 810, when the number of consumables remaining after one is used reaches a preselected number, an order is indicated to the user associated with the administrative device 134. In accordance with one embodiment of the subject application, the user associated with the user account, via the administrative device 134, selects a threshold level at which additional consumables must be ordered, so as to maintain a desired inventory level.

Imminent replacement data is then generated at step 812 for each document processing device 104, 114, and/or 124 for which the status data indicates a low level. That is, for each of the document processing devices 104, 114, and 124 that have low, or empty levels of a given consumable, imminent replacement data is generated by the administrative device 134, by the inventory server 138, a respective controller 108, 118, 128, or other suitable monitoring device associated with the document processing devices 104, 1114, and 124. In accordance with one embodiment of the subject application, such imminent replacement data is communicated to the administrative device 134 and/or the inventory server 138 for notification of the administrative user. The imminent replacement data is then compared, at step 814, with the inventory value so as to determine whether the replacement of the consumable with a consumable from inventory will result in the inventory dropping below the preselected threshold. An order is then indicated for additional consumables, at step 816, in accordance with the results of the comparison performed at step 814.

Referring now to FIG. 9, there is shown a flowchart 900 illustrating a method for monitoring consumable usage and managing consumable inventory in accordance with one embodiment of the subject application. The methodology of FIG. 9 begins at step 902, whereupon the administrative device 134, the server 138, or other suitable device, e.g. controllers 108, 118, or 128, associated with the computer network 102, initiate a monitoring component associated with a user account so as to monitor inventory 144 and consumable status of the computer network 102. It will be appreciated by those skilled in the art that the consumable status corresponds to the levels of consumables, e.g. paper, toner, binders, output media, etc., associated with each of the document processing devices 104, 114, and 124. FIG. 9 is discussed hereinafter with respect to the administrative device 134 initiating and operating the monitoring component for example purposes only, and the skilled artisan will appreciate that any other suitable device of the computer network 102 is capable of performing the monitoring and analysis of FIG. 9.

At step 904, the administrative device 134 analyzes the inventory 144 so as to determine the quantities of consumables stored therein. In accordance with one embodiment of the subject application, the server 138 maintains an inventory database 140 detailing the consumables, quantities, and the like, associated with the inventory 144. Thus, in such an embodiment the administrative device 134 communicates with the server 138 so as to analyze the inventory 144 of available consumables.

A determination is then made at step 906 whether any consumable in the inventory 144 meets a minimum inventory level. That is, a determination is made whether any consumable is at a minimum quantity available in inventory 144. In accordance with one embodiment of the subject application, the minimum inventory level is preselected by the administrator associated with the user account. For example, in the system 100, with three document processing devices 104, 114, and 124, the administrator may select a minimum threshold of five replacement cyan color toner cartridges, thereby ensuring a ready supply of replacements. Upon a determination that the minimum inventory level has been met, flow proceeds to step 934, whereupon the administrative user associated with the user account is notified of the amount in inventory 144.

The administrative device 134 then generates a display of the inventory value associated with the consumable at the minimum level at step 936. Preferably, the display includes information regarding the type of consumables contained within the inventory 144. At step 938, an order is indicated via the administrative device 134 for additional consumables for the user account. For example, a prompt is generated via an associated graphical user interface prompting the user to purchase, or order, the additional consumables. A suitable order is then placed at step 940 for a selected amount of consumables based upon the displayed inventory. It will be appreciated by those skilled in the art that the placement of the order is capable of being accomplished via, for example and without limitation, a third-party web retailer, a vendor, a retail establishment, or the like. The inventory value is then updated in accordance with the amount of the consumable ordered at step 942. At step 944, the inventory value is then updated based upon the ordered information, i.e. the data stored in the inventory database 140. Thereafter, flow proceeds from step 944 to step 908, discussed in greater detail below.

Returning to step 906, upon a determination that the minimum inventory level has not been met, flow progresses to step 908, whereupon consumable status data is received from each document processing device 104, 114, and 124 associated with the user account. In accordance with one embodiment of the subject application, the status data is representative of the level of consumable present in the respective device 104, 114, and 124. For example, the status data of the document processing device 104 includes the number of sheets of A4 paper remaining, the amount of black, cyan, magenta, and yellow toners, etc. Preferably, the status level of each consumable corresponds to a full level, an empty level, a low level, or the like.

A determination is then made by the monitoring component associated with the administrative device 134 at step 910 whether any status data received from the document processing devices 104, 114, and 124 indicates a low level of a consumable. In accordance with one embodiment of the subject application, the determination includes the identity of the document processing device 104, 114, or 124, the type of consumable, the color, the remaining amount of the consumable, and the like. When no devices 104, 114, or 124 have a low level, as determined from the received status data, the monitoring component of the administrative device 134 continues to receive status data at step 908.

When it is determined at step 910 that at least one consumable has a corresponding low level based upon its associated status data flow proceeds to step 912. At step 912, imminent replacement data is generated by the monitoring component of the administrative device 134 for each document processing device 104, 114, and 124 having a low level consumable status. An inventory value is then retrieved from the inventory database 140 by the administrative device 134 via the server 138 and compared to the imminent replacement data at step 914. A suitable graphical user interface is then generated on the administrative device 134 displaying the inventory value and the imminent replacement data at step 916. Preferably, the graphical user interface includes an identification of the device or devices 104, 114, and 124 requiring consumable replacement, the type of consumable, and the like.

A determination is then made at step 918 whether an order is indicated based upon the results of the inventory value and replacement data comparison. That is, a determination is made by the monitoring component of the administrative device 134 whether the withdrawal of the consumable from inventory 144 will necessitate the ordering of a replacement consumable from a vendor. When an order for additional consumables is not necessary, flow proceeds directly to step 926, discussed below. Upon a determination at step 918 that an order for additional consumables is necessary, flow proceeds to step 920, whereupon the user associated with the user account is prompted to place an order for additional replacement consumables. The monitoring component then determines whether or not the order has been placed at step 922.

Once the order has been placed, operations proceed to step 924, whereupon the inventory amount displayed to the user via the administrative device 134 is suitably updated. It will be understood by those skilled in the art that the inventory database 140 is also capable of being suitably updated in accordance with the placed order. Operations then proceed to step 926, whereupon a determination is made whether the status data associated with the document processing device 104, 114, or 124 for which a replacement was made has transitioned to a full level of the consumable. The skilled artisan will appreciate that such a determination indicates that the low level consumable has been replaced, hence the full level indication. If the status data does not reflect a full level of the consumable, flow proceeds to step 932, whereupon the user is prompted to have the consumable suitably replaced.

After detection of the transition to a full level from corresponding status data, the inventory value associated with the consumable is decremented so as to indicate the consumable is no longer available in the inventory 144 at step 928. The inventory amount in the inventory database 140 and displayed on the administrative device 134 is then suitably updated in accordance with the decremented inventory value at step 930. Flow with respect to FIG. 9 then returns to step 906, whereupon operations continue as set forth above.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A system for monitoring consumable usage and managing consumable inventory comprising:
means adapted for receiving at least one order for document processing device consumables from a user account;
storage means adapted for storing an inventory value associated with the user account corresponding to each received order;
means adapted for receiving consumable status data from each of a plurality of document processing devices associated with the user account, the status data including data representative of a status of full level, a status of empty level, and a status of low level relative to consumables used with the document processing device;
means adapted for decrementing the inventory value during each transition reflected in the status data to a full level;
order indication means adapted for indicating an order for additional consumables for the user account when the inventory level is decremented to a preselected trigger amount;
means adapted for generating imminent replacement data corresponding to each document processing device having a low level consumable status; and
comparison means adapted for comparing the inventory value to the imminent replacement data; and wherein
the order indication means further includes means adapted for indicating an order for additional consumables in accordance with an output of the comparison means.

2. The system of claim 1 wherein the consumable includes toner for use in the document processing device.

3. The system of claim 1 further comprising:
display means adapted for displaying the inventory value and the status value; and
means adapted for placing an order for a selected amount of consumable in accordance with the displayed inventory value and status value, wherein the selected amount is reflected in the inventory value.

4. The system of claim 2 wherein the consumables include multiple toner colors, and wherein the inventory value includes values associated with each toner color.

5. A method for monitoring consumable usage and managing consumable inventory comprising the steps of:
receiving at least one order for document processing device consumables from a user account;
storing an inventory value associated with the user account corresponding to each received order;
receiving consumable status data from each of a plurality of document processing devices associated with the user account, the status data including data representative of a status of full level, a status of empty level, and a status of low level relative to consumables used with the document processing device;
decrementing the inventory value during each transition reflected in the status data to a full level;
indicating an order for additional consumables for the user account when the inventory level is decremented to a preselected trigger amount;
generating imminent replacement data corresponding to each document processing device having a low level consumable status;
comparing the inventory value to the imminent replacement data; and
indicating an order for additional consumables in accordance with an output of the comparison step.

6. The method of claim 5 wherein the consumable includes toner for use in the document processing device.

7. The method of claim 5 further comprising the steps of:
displaying the inventory value and the status value; and
placing an order for a selected amount of consumable in accordance with the displayed inventory value and status value, wherein the selected amount is reflected in the inventory value.

8. The method of claim 6 wherein the consumables include multiple toner colors, and wherein the inventory value includes values associated with each toner color.
